(19) United States
(12) Patent Application Publication
(10) Pub. No.: US 2023/0180667 A1
(43) Pub. Date: Jun. 15, 2023

(54) BALE WRAPPING SYSTEM

(71) Applicant: AGCO International GmbH, Neuhausen (CH)

(72) Inventor: Malte Cornelius Schlichting, Wolfenbuttel (DE)

(21) Appl. No.: 18/045,889

(22) Filed: Oct. 12, 2022

(30) Foreign Application Priority Data
Dec. 13, 2021 (GB) 2117952.8

(51) Int. Cl. A01F 15/07

(52) U.S. Cl. CPC A01F 15/0715; A01F 2015/076; A01F 2015/0745

(57) ABSTRACT

Systems and methods are provided for controlling operation of one or more controllable components of an agricultural baler. Using a moisture level of material collected by the agricultural baler a baling strategy including an indication of a wrapping material for a formed bale is determined. Methods include controlling one or more operational components associated with the baler in dependence on the determined baling strategy to control the wrapping process in accordance with the determined baling strategy.

### CROSS-REFERENCE TO RELATED APPLICATION

This application claims the benefit of the filing date of U. K. Patent Application 2117952.8, “Bale Wrapping System,” filed Dec. 13, 2021, the entire disclosure of which is incorporated herein by reference.

### FIELD

Embodiments of the present disclosure relate generally to agricultural balers, and in particular to a bale wrapping system forming part of or for use with agricultural balers and the like.

### BACKGROUND

It is known to provide baling systems which allow an operator to choose between twine wrapping or net wrapping or other binding materials. Twine wrapping is advantageously cheaper when compared with net wrap, however the process is slower as it needs to be wrapped around the formed bales more times, (ca. 20 revolutions compared with 2-4 revolutions for net wrapping). Some systems additionally allow for an operator to set a desired number of revolutions of the selected wrapping material.

For high moisture bales, e.g. cut grass, it is known to wrap in net wrap and then overwrap with plastics film (either in the baler or on a separate wrapping apparatus). The over wrapping creates an anaerobic environment allowing controlled fermentation of the cut grass as it becomes animal feed. Other systems/methods involve wrapping the formed bale directly with film, but there can be issues with stalks poking through and thereby ruining an entire bale of feed (e.g. where the grass rots rather than ferments if not completely sealed). Though if this does not happen such film wrapped bales are low maintenance for the farmer (and use of the more expensive net wrap is avoided).

As multiple different baling strategies may be employed by an operator using a single baler, e.g. depending on time of year, crop type etc. it is advantageous to provide a system which allows for the wrapping materials to be interchanged. A known solution includes use of a carousel which holds multiple different kinds of wrapping material (i.e. a selection of net wrap and film wrap). This allows different kinds of wrapping material to be carried by a single baler. At present the operator selects the kind of wrap desired and manually feeds this from the relevant carousel station to a wrapping apparatus within the baling chamber of the baler. However, switching between different material types for the wrapping material can be time consuming and labor intensive. It can also be difficult for an operator to assess and determine an appropriate wrapping material for the material being collected by the baler.

### BRIEF SUMMARY

In some embodiments, a control system for controlling operation of one or more controllable components of an agricultural baler comprises one or more controllers, and is configured to: receive data indicative of a moisture level of material collected by the agricultural baler; determine, in dependence on the moisture level, a baling strategy for forming the collected material into a bale, the baling strategy including an indication of wrapping material for the formed bale; and generate and output one or more control signals for controlling one or more operational components associated with the baler in dependence on the determined baling strategy.

Advantageously, the control system may determine a baling strategy based on moisture content of the collected material. This ensures an appropriate binding and/or wrapping of the collected material or the formed bale to mitigate problems discussed herein.

The baling strategy may comprise one or more of: a wrapping material type; a combination of wrapping materials; a number of wraps of a wrapping material; and a thickness for a wrapping material. The wrapping material type may include net wrap, or twine wrap, for example. The wrapping material type may include a plastics film, for example.

The one or more operational components may comprise a user interface, such as a display screen. The user interface may be operable to provide information indicative of the determined baling strategy to an operator of the baler. The control system may be configured to generate and output the one or more control signals for controlling operation of the user interface to display the determined baling strategy to an operator of the agricultural baler.

The operational component may comprise a carousel for automating loading of one or more wrapping materials into a wrapping apparatus associated with the agricultural baler for wrapping of the collected material in accordance with the determined baling strategy. The control system may be configured to generate and output the one or more control signals for automatically controlling the carousel to load the one or more wrapping materials.

The baling strategy may comprise firstly wrapping the collected material with a first wrapping material and subsequently over wrapping the bound material with a second wrapping material.

The control system may be configured to: receive sensor data from a moisture sensor associated with the agricultural baler; and determine a moisture level of the collected material in dependence thereon. The moisture sensor may comprise one or more of: an infrared sensor, a resistive sensor, an optical sensor; and a capacitive sensor. The moisture sensor may be mounted or otherwise coupled to the agricultural baler and configured to monitor material collected into the baler. The moisture sensor may be mounted or otherwise coupled to the agricultural baler and configured to monitor material being collected by a crop pick-up of the baler. The moisture sensor may be configured to monitor material within a baling chamber of the baler.

The control system may be configured to determine an expected moisture level in dependence on data indicative of the operating environment of the baler. The operating environment data may comprise a mapped environment comprising information indicative of a measured or expected moisture level for material at one or more locations within the mapped environment. The operating environment data may comprise an indication of one or more environmental conditions, including one or more of: a temperature, a time of year; a time of day; a rainfall measurement; and a humidity.

The control system may be configured to receive a user input indicative of a moisture level provided by an operator of the baler and determine the baling strategy in dependence thereon. The user input may be provided via a user interface of the baler, for example.

In certain embodiments, a system comprises: a carousel for loading a plurality of different wrapping materials onto a wrapping apparatus; and a control system configured to control operation of the carousel and/or wrapping apparatus in accordance with a determined baling strategy.

In some embodiments, an agricultural baler comprises and/or is controllable by a control system, or comprises a system as described herein.

In further embodiments, a method of controlling operation of one or more controllable components of an agricultural baler comprises: receiving data indicative of a moisture level of material collected by the agricultural baler; determining, in dependence on the moisture level, a baling strategy for forming the collected material into a bale, the baling strategy including an indication of a wrapping material for the formed bale; and controlling one or more operational components associated with the baler in dependence on the determined baling strategy.

The baling strategy may comprise one or more of: a wrapping material type; a combination of wrapping materials; a number of wraps of a wrapping material; and a thickness for a wrapping material. The wrapping material type may include net wrap, or twine wrap, for example. The wrapping material type may include a plastics film, for example.

The one or more operational components may comprise a user interface, such as a display screen. The user interface may be operable to provide information indicative of the determined baling strategy to an operator of the baler. The method may include controlling operation of the user interface to display the determined baling strategy to an operator of the agricultural baler.

The operational component may comprise a carousel for automating loading of one or more wrapping materials into a wrapping apparatus associated with the agricultural baler for wrapping of the collected material in accordance with the determined baling strategy. The method may comprise controlling the carousel to load the one or more wrapping materials.

The baling strategy may comprise firstly wrapping the collected material with a first wrapping material and subsequently over wrapping the bound material with a second wrapping material.

The method may include: receiving sensor data from a moisture sensor associated with the agricultural baler; and determining a moisture level of the collected material in dependence thereon. The moisture sensor may comprise one or more of: an infrared sensor, a resistive sensor, an optical sensor; and a capacitive sensor. The moisture sensor may be mounted or otherwise coupled to the agricultural baler and configured to monitor material collected into the baler. The moisture sensor may be mounted or otherwise coupled to the agricultural baler and configured to monitor material being collected by a crop pick-up of the baler. The moisture sensor may be configured to monitor material within a baling chamber of the baler.

The method ay include determining an expected moisture level in dependence on data indicative of the operating environment of the baler. The operating environment data may comprise a mapped environment comprising information indicative of a measured or expected moisture level for material at one or more locations within the mapped environment. The operating environment data may comprise an indication of one or more environmental conditions, including one or more of: a temperature, a time of year; a time of day; a rainfall measurement; and a humidity.

The method may include receiving a user input indicative of a moisture level provided by an operator of the baler and determine the baling strategy in dependence thereon. The user input may be provided via a user interface of the baler, for example.

In some embodiments, computer software comprises computer-readable instructions which, when executed by a processor, cause performance of a method described herein.

A non-transitory computer readable storage medium may comprise the computer software described.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Embodiments will now be described, by way of example only, with reference to the accompanying drawings, in which:

FIG. 1 is a side view illustrating an agricultural baler;

FIG. 2 is a perspective view of the baler shown in FIG. 1;

FIG. 3 is a further perspective view of the baler shown in FIG. 1 and FIG. 2;

FIG. 4 is a side cross-sectional view of the baler shown in the FIGS. 1 to 3;

FIG. 5 shows a schematic perspective view of elements of a wrapping apparatus;

FIG. 6 is a further schematic diagram illustrating the wrapping apparatus of FIG. 5;

FIG. 7 is a schematic diagram illustrating an embodiment of a control system;

and

FIG. 8 is a schematic diagram of a tractor-baler combination.

### DETAILED DESCRIPTION

In general, the figures illustrate an agricultural baler 10, including the use of moisture sensors (e.g. sensor 50) for determining a moisture level of crop material collected by the baler 10 and subsequent control thereof of a carousel 52 for selecting and feeding a determined wrapping material to a wrapping mechanism of the baler 10, that selection made in dependence on a determined baling strategy.

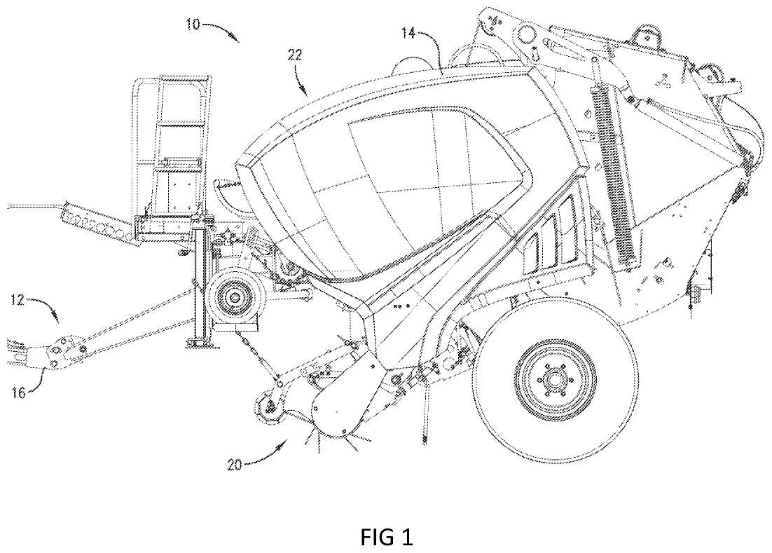

FIG. 1 shows an agricultural baler 10. Although for simplicity aspects of the disclosure will be described in detail with respect to the agricultural baler 10, the disclosure is not limited to the agricultural baler 10 and may be employed on various types of agricultural equipment. For example, although the agricultural baler 10 is a round baler, aspects of the disclosure may be included on a square baler or other type of baler.

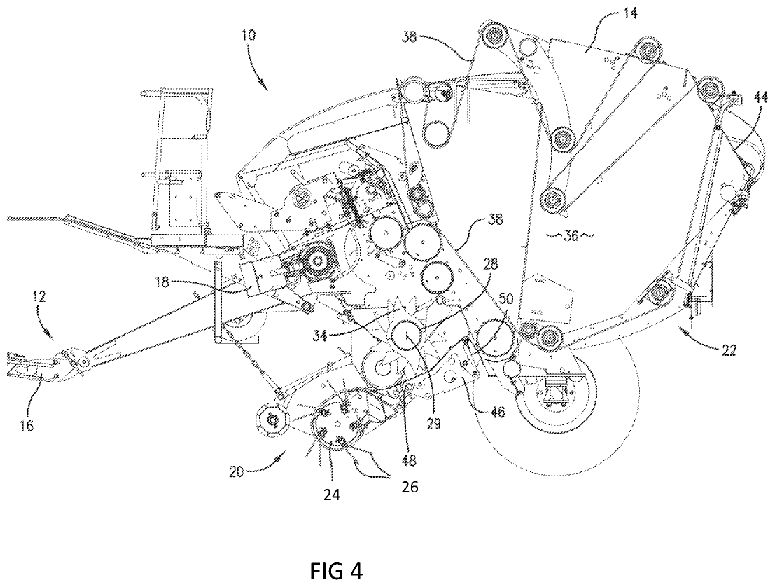

The agricultural baler 10 generally includes a towing and driveline portion 12 extending from a main body 14. The towing and driveline portion 12 includes a tow hitch 16 configured to be connected to a towing vehicle such as a tractor (e.g. tractor 1) or the like during operation, such that the baler 10 is pulled in a forward direction along a windrow of dried hay or similar crop lying in a field. The towing and driveline portion 12 may also include driveline connections 18 (FIG. 4) for operably connecting the drivable features of the agricultural baler 10 (i.e., the pickups, rotor, baling mechanism, etc., which will be discussed in more detail below) to a power take-off (PTO) portion of the towing vehicle.

The main body 14 generally includes a crop pickup portion 20 and a baling portion 22. During operation, the crop pickup portion 20 engages the cut hay or other crop lying in a field and conveys it upward and rearward towards the baling portion 22. The baling portion 22 in turn compresses the hay into a desired shape (in the case of a round baler, into a cylindrical bale), wraps the bale, and ejects the bale into the field for later retrieval.

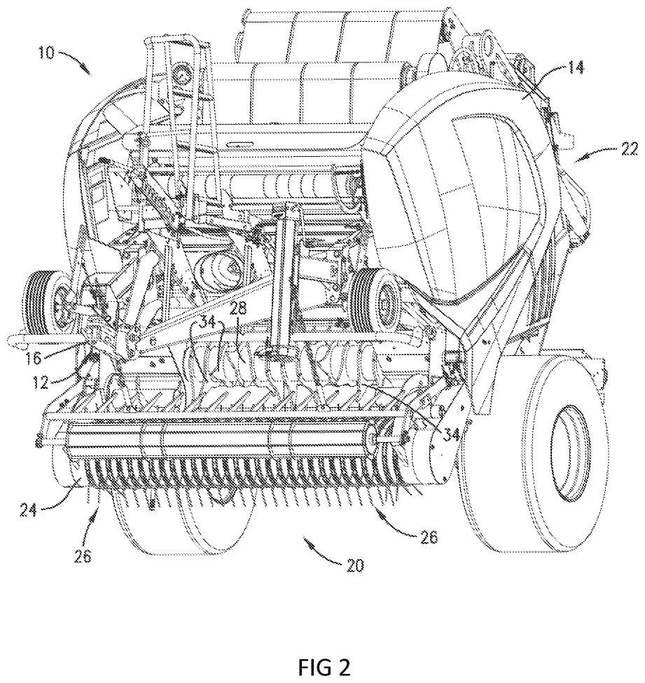

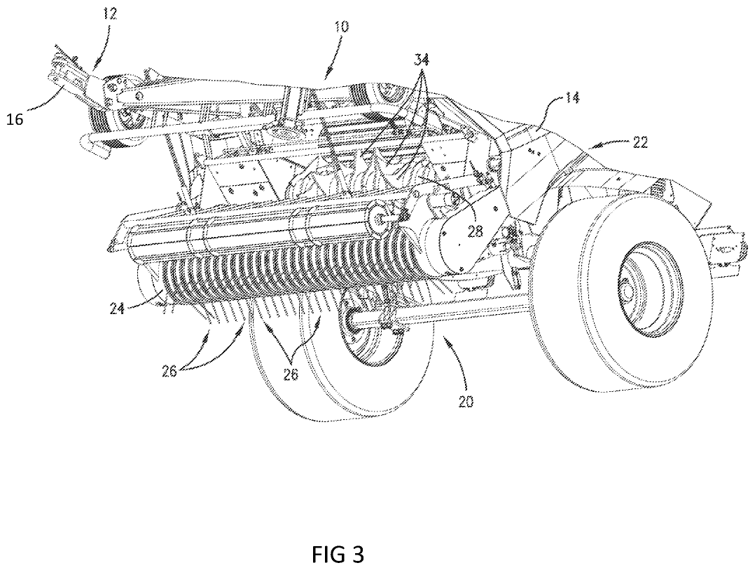

FIGS. 2 and 3 show the crop pickup portion 20 in more detail. The crop pickup portion 20 includes a rotary rake 24 that engages the hay or other crop in a windrow. The rotary rake 24 includes a plurality of spinning tines 26 that contact the hay or other crop as the agricultural baler 10 is towed forward and flings the hay or other crop upwards and rearwards toward the baling portion 22. The crop pickup portion 20 may further include a rotor 28 that is configured to stuff the hay or other crop into the baling portion 22. In some embodiments, the crop pickup portion 20 may include one or more augers operably coupled to the rotor 28 and sandwiching a plurality of stuffers 34 or else provided upstream of the rotor 28. When the hay or other crop leaves the rotary rake 24, the augers center the hay and the spinning stuffers 34 of the rotor 28 pack the hay into the baling portion 22.

FIG. 4 shows the baling portion 22 in more detail. The baling portion 22 generally includes a baling chamber 36, a plurality of compression belts 38, and a wrapping mechanism 60. The rotor 28 stuffs the hay or other crop into the baling chamber 36, and more particularly into the compression belts 38 provided in the baling chamber 36. The rotating compression belts 38 continuously roll the hay or other crop and apply pressure thereto, therefore compacting the hay or other into a densely packed bale. The compression belts 38 are expandable such that as more and more hay or other crop enters the baling chamber 36, the circumference of the portion of the belts 38 pressing on the bale 42 expands as the outer circumference of the bale 42 expands with the addition of more hay or other crop 55 being added to the bale 42. Once the desired size of the bale 42 is achieved, the wrapping mechanism 60 wraps the outer circumference of the bale 42 in plastic, netting, or another desired wrapping material. As discussed herein, the selection of the desired wrapping material may be based primarily on a moisture level associated with the collected crop material. Finally, a movable tailgate 44 of the agricultural baler 10 swings open and the wrapped bale 42 is ejected into the field for later collection.

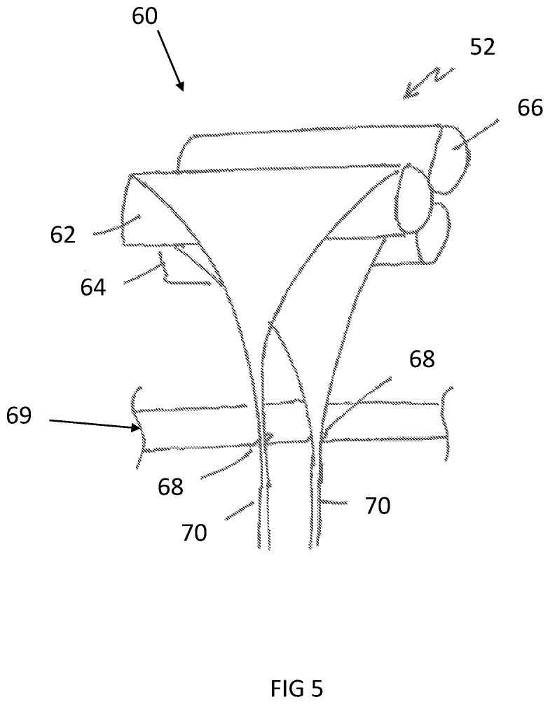

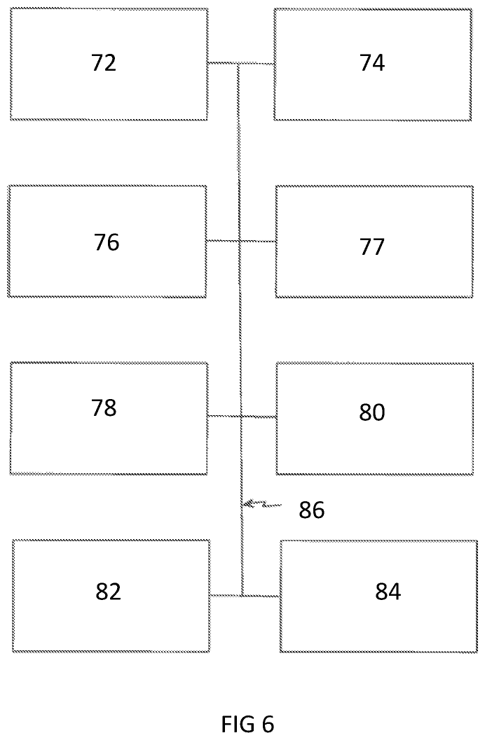

Elements of an automated wrapping mechanism 60 operable under the control system are shown in FIGS. 5 and 6.

The wrapping mechanism 60 includes carousel 52, housing first, second and third rolls of wrapping material 62, 64, 66 as shown in FIG. 5. At least two of the rolls are of differing kinds of wrapping material, for example a first may be netwrap and a second may be plastics film. In the illustrated embodiment the first and second rolls 62, 64 are of differing kinds of wrapping material.

The carousel 52 may conveniently comprise a wrapping material storage system in which a number of wrapping material supports are provided adapted to be indexed about a central support axis. Each roll of wrapping material 62, 64, 66 is located on an associated support. A drive mechanism 82 is provided for indexing the wrapping material supports. Each roll of wrapping material has a leading edge.

When initially loading each roll of wrapping material an operator pays out the leading edge of the wrapping material and gathers the leading edge of the wrapping material to form a rope or gathered string 70 of wrapping material. The operator then inserts the gathered string of wrapping material into a suitable slot or retention notch 68, formed in a suitable support 69.

In FIG. 5, the support 69 is shown as a frame element of the baler 1 located beneath the carousel 52 with two retention notches 68. However, the support 69 may be located in any suitable location and, for example, may be formed in the side frame of the wrapping material storage system. In such an arrangement, each retention notch 68 may be formed adjacent the respective roll of wrapping material.

A pair of feed rollers are provided adjacent a wrapping material inlet of a baling chamber (not shown). The feed rollers are operated by a drive mechanism 74 actuated by a local control unit 72 normally to rotate the feed rollers in a feed direction so as, when the leading edge of the wrapping material is caught by the pair of rotating feed rollers, draws the wrapping material from the carousel 52 and into the baling chamber 36.

The feed apparatus further comprises a displacement apparatus configured to move the gathered string between a first position in which the gathered string is located at least in part within its retention notch 68 and a second position in which the gathered string is located at least in part in contact with the pair of feed rollers.

In a preferred arrangement the displacement apparatus comprises a moveable arm with a grabbing device. Drive mechanisms 76, 77 are provided to control movement of the movable arm and operation of the grabbing device. These drive mechanisms 76, 77 are actuated by the control unit 72.

A severing apparatus is provided at a severing location downstream of the feed rollers. A drive mechanism 78 for the severing apparatus is actuated by the control unit 72 to cause severing of the wrapping material once the formed bale has been sufficiently wrapped.

A gathering apparatus is provided between the reservoir and the pair of feed rollers 74. On actuation of a drive mechanism 80 for the gathering apparatus by the control unit 72, the side edges of the wrapping material are gathered together to form a string of the wrapping material. It will be understood that where the wrapping material is a film wrapping material the gathering apparatus 80 will be actuated toward the end of each wrapping operation as is usual in wrapping of bales with a film wrapping material. In this way, when wrapping with a film wrapping material a string of wrapping material is reformed at the end of each baling operation.

The control unit 72 is in electronic communication with the various drive mechanisms 74, 76, 77, 78, 80, 82 by way of a suitable network 86 in order to control operation of the loading of the wrapping material, e.g. under instruction of control system 100—see below, and in accordance with a determined baling strategy as is described herein.

Prior to commencement of a wrapping operation all of the strings 70 of wrapping material are located in their respective notches. In order for wrapping to commence, the drive mechanisms 76, 77 of the displacement apparatus are actuated to grab an appropriate string of wrapping material and remove it from its retention notch 12. The string of wrapping material is then moved such that a leading edge of the string of wrapping material contacts the pair of feed rollers. Actuation of the feed roller drive mechanism 74 then causes the wrapping material to be drawn from the carousel 52 and into the baling chamber 36.

As the wrapping material is drawn into the baling chamber 36 the edges of the wrapping material move apart such that wrapping material will flow evenly from the carousel 52 through the pair of feed rollers to the baling chamber 36.

Once the bale has been sufficiently wrapped the drive mechanism 78 of the severing mechanism is actuated to sever the wrapping material.

Where the baling strategy for a subsequent bale indicates to continue wrapping with the current wrapping material, no further changes are required.

If a wrapping material roll is exhausted (this may be detected by a suitable sensor in communication with the control unit 72, for example), the control unit 72 may be actuated to cause the wrapping material support system to be indexed such that a fresh roll of wrapping material is in a suitable location to allow for the string of wrapping material to be removed from its retention notch 68 and guided towards the pair of feed rollers.

If an operator desires to wrap a bale in a different wrapping material, e.g. because of the suggested baling strategy as determined by control system 100, this may be communicated to the control unit 72, for example by way of a user input device, e.g. in the form of a display screen 54 in communication with the control unit 72. In alternative embodiments, the control system 100 may automatically control swapping of wrapping materials through automatic communication with the control unit 72 in accordance with the determined baling strategy.

If the current wrapping material is a film wrapping material, the drive mechanism 74 of the pair of feed rollers is reversed, freeing the string of wrapping material so that it may be grabbed by the displacement apparatus and returned to a suitable retention notch 68.

If the current wrapping material is a netwrap wrapping material, the control unit 72 actuates the drive mechanism 80 of the gathering apparatus in order to draw the sides of the wrapping material together to form a string. The drive mechanisms 76, 77 of the displacement apparatus are actuated to grab the string of wrapping material and direct the string of wrapping material to a suitable retention notch 68.

If the operator knows which is to be the final bale using netwrap, e.g. in dependence on the determined baling strategy, the gathering device may be actuated during the final baling. Alternatively, the gathering apparatus can be actuated to draw the netwrap wrapping material into a string while the baler is inactive. Once the netwrap has been drawn into a string the control unit 72 actuates the drive mechanism 74 of the pair of feed rollers to reverse and so free the string of netwrap wrapping material from the pair of feed rollers before the displacement apparatus is actuated to move the string of gathered netwrap wrapping material to the relevant retention notch 68.

The control unit 72 then causes the wrapping material support system to be indexed such that a string of the desired wrapping material is in a position to be grabbed and guided towards the pair of feed rollers.

The drive mechanisms 76, 77 of the displacement apparatus are then once again actuated to grab the string of wrapping material and deliver the string of desired wrapping material to the pair of feed rollers.

As will be discussed in detail herein, the baler 10 additionally includes one or more moisture sensors for monitoring a moisture level associated with the crop material collected at the crop pick up portion 20. In the illustrated embodiment the moisture sensor comprises a capacitive moisture sensor 50 mounted on an interior wall of the baling chamber 36. The capacitive sensor 50 has a sensing element which contacts the crop material within the baling chamber 36 in use to obtain the measurement of the moisture level associated with the crop material, as is known in the art. The moisture sensor 50 is used by a control system 100 of the baler 10, to determine a moisture level associated with the collected crop material and determine therefrom an appropriate baling strategy for the material, including an identification of an appropriate wrapping material or wrapping material combination for the bale.

As discussed herein, the baling strategy may be used by the control system 100 for controlling operational components of the baler 10, including a carousel 52 for automating loading of different wrapping materials into the baling chamber 36 for wrapping the collected material in accordance with the determined baling strategy, e.g. in the manner discussed hereinabove, and/or control over a user interface 54 associated with the baler 10, e.g. provided as a display terminal of a coupled tractor 1 or indeed a handheld terminal, to provide an indication of the determined baling strategy to an operator of the baler 10.

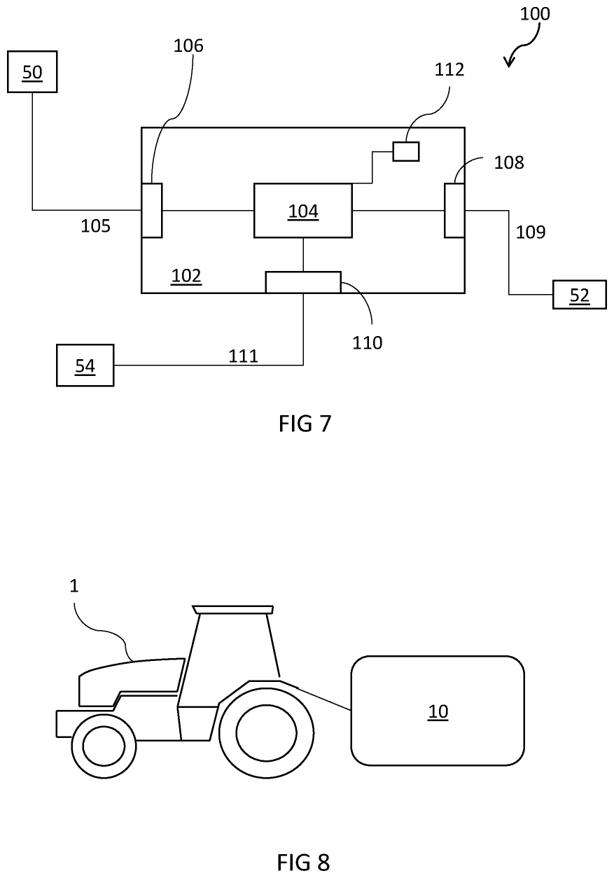

FIG. 7 illustrates the control system 100 further. As shown, control system 100 comprises a controller 102 having an electronic processor 104, an electronic inputs 106 and electronic outputs 108, 110. The processor 104 is operable to access a memory 112 of the controller 102 and execute instructions stored therein to perform the steps and functionality discussed herein, e.g. by controlling the user interface 54, to indicate, e.g. to an operator of the baler 10, information indicative of the determined baling strategy, and/or controlling operation of the carousel 52 through generation and output of one or more control signals thereto, or to a local control unit of the carousel 52, e.g. control unit 72.

The processor 104 is operable to receive sensor data via input 106 which, in the illustrated embodiment, takes the form of input signals 105 received from the moisture sensor 50. Using this data, the processor 104 is configured to analyze the data and determine therefrom a measure of a moisture level associated with the material collected by the baler 10. As discussed herein, the determined moisture level is used to determine a baling strategy for the baler 10, and in particular an indication of a wrapping material for the formed bale. A notification indicative thereof can be presented to an operator of the baler 10 via the user interface 54—see below.

As described above, the controller 102 includes an electronic output 108 configured output control signals 109 generated by the processor 104 for controlling operation of the carousel 52. Specifically, processor 104 is operable to generate, and the controller 102 operable to then output via output 108, control signals 109 for controlling operation of the carousel 52 in the manner described herein, e.g. through selection of the appropriate wrapping material (as determined by the baling strategy), rotating the carousel 52 into position and subsequently loading the selected wrapping material into the baling chamber 36 of the baler 10 for wrapping the collected material. As will be appreciated, the controller 102 may output the control signals 109 to a local processing unit, e.g. control unit 72, of the carousel 52 for controlling operation thereof.

Output 110 is operably coupled to the user interface 54 of the baler 10. Here, the control system 100 is operable to control operation of the user interface 54, e.g. through output of control signals 111 in order to display data to an operator of the baler 10 relating to the operation of the control system 100. Specifically, the control system 100 is operable to control the user interface 54 to display to the operator an indicator of the baling strategy.

FIG. 8 illustrates an agricultural vehicle in the form of a tractor 1 operably coupled to baler 10. It will be appreciated that, in use, the tractor 1 and baler 10 may be operably coupled at tow hitch 16 of the baler 10, although other couplings are envisaged and will be appreciated by the skilled reader.

All references cited herein are incorporated herein in their entireties. If there is a conflict between definitions herein and in an incorporated reference, the definition herein shall control.

What is claimed is:

1. A control system for controlling operation of at least one controllable component of an agricultural baler, the control system comprising at least one controller, and being configured to:
receive data indicative of a moisture level of material collected by the agricultural baler;
determine, based at least in part on the moisture level, a baling strategy for forming the collected material into a bale, the baling strategy including an indication of a wrapping material for the formed bale; and
generate and output at least one control signal for controlling at least one operational component associated with the baler based at least in part on the determined baling strategy.

2. The control system of claim 1, wherein the baling strategy comprises at least one selected from the group consisting of:
a wrapping material type;
a combination of wrapping materials;
a number of wraps of a wrapping material; and
a thickness for a wrapping material.

3. The control system of claim 1, wherein the at least one operational component comprises a user interface operable to provide information indicative of the determined baling strategy to an operator of the agricultural baler.

4. The control system of claim 3, configured to generate and output the at least one control signal for controlling operation of the user interface to display the determined baling strategy to an operator of the agricultural baler.

5. The control system of claim 1, wherein the operational component comprises a carousel for automating loading of at least one wrapping material into a wrapping apparatus associated with the agricultural baler wrapping of the collected material in accordance with the determined baling strategy.

6. The control system of claim 5, configured to generate and output the at least one control signal for automatically controlling the carousel to load the at least one wrapping material into a wrapping apparatus of the baler.

7. The control system of claim 1, wherein the baling strategy comprises firstly wrapping the collected material with a first wrapping material and subsequently over wrapping the bound material with a second wrapping material.

8. The control system of claim 1, configured to:
receive sensor data from a moisture sensor associated with the agricultural baler; and
determine a moisture level of the collected material based at least in part on the sensor data.

9. The control system of claim 8, wherein the moisture sensor comprises at least one sensor selected from the group consisting of an infrared sensor, a resistive sensor, an optical sensor, and a capacitive sensor.

10. The control system of claim 8, wherein the moisture sensor is coupled to the agricultural baler and configured to monitor material collected into the baler.

11. The control system of claim 10, wherein the moisture sensor is coupled to the agricultural baler and configured to monitor material being collected by a crop pick-up of the agricultural baler.

12. The control system of claim 10, wherein the moisture sensor is coupled to the agricultural baler and configured to monitor material within a baling chamber of the agricultural baler.

13. The control system of claim 1, configured to determine an expected moisture level based at least in part on data indicative of the operating environment of the agricultural baler.

14. The control system of claim 13, wherein the operating environment data comprises a mapped environment comprising information indicative of a measured or expected moisture level for material in at least one location within the mapped environment.

15. The control system of claim 13, wherein the operating environment data comprises an indication of at least one environmental condition selected from the group consisting of a temperature, a time of year, a time of day, a rainfall measurement, and a humidity.

16. The control system of claim 1, configured to receive a user input indicative of a moisture level provided by an operator of the agricultural baler and determine the baling strategy based at least in part on the moisture level.

17. An agricultural baler comprising the control system of claim 1.

18. A system, comprising:
a carousel for loading a plurality of different wrapping materials onto a wrapping apparatus; and
the control system of claim 1, configured to control operation of at least one of the carousel and the wrapping apparatus in accordance with the determined baling strategy.

19. An agricultural baler comprising the system of claim 18.

20. A method of controlling operation of at least one controllable component of an agricultural baler, the method comprising:
receiving data indicative of a moisture level of material collected by the agricultural baler;
determining, based at least in part on the moisture level, a baling strategy for forming the collected material into a bale, the baling strategy including an indication of a wrapping material for the formed bale; and
controlling at least one operational component associated with the baler based at least in part on the determined baling strategy.
